(19) United States
(12) Patent Application Publication
(10) Pub. No.: US 2009/0306835 A1
(43) Pub. Date: Dec. 10, 2009

(54) Agricultural vehicle and method of operation therefor

(76) Inventors: Klaus Martin Ellermann, Lage (DE); Helmut G. Konrad, Salzkotten (DE); Thomas Hansen, Büren (DE)

Correspondence Address: CHRISTINE JOHNSON ESQ., 151 Trenton Rd., Fairless Hills, PA, 19030, US

(21) Appl. No.: 12/475,624

(22) Filed: Jun. 1, 2009

(30) Foreign Application Priority Data
Jun. 6, 2008 (DE) 10 2008 027 282.5

(51) Int. Cl. G06F 7/00

(52) U.S. Cl. 701/2; 701/50

(57) ABSTRACT

An agricultural vehicle can be switched between a driver-controlled driven mode in which the direction and speed of travel of the vehicle are determined by the driver and a remotely controlled driven mode in which the direction and speed of travel of the vehicle are determined by information received from outside. In the remotely controlled driven mode, a control arrangement able to be operated by the driver is monitored (S4, S6, S7), and the vehicle is switched back to the driver-controlled mode (S5) if an intervention by the driver of a first type at the control arrangement is sensed. In the event of an intervention by the driver of a second type (S8, S10), the remotely controlled mode is maintained and a correction determined by the intervention taken by the driver is made (S9, S11) to the movement of the vehicle as determined by the information received from outside.

### CROSS REFERENCE TO RELATED APPLICATIONS

This application claims priority to German patent application no. DE 10 2008 027 282.5, filed Jun. 6, 2008 in the Germany Patent Office.

### FIELD OF THE INVENTION

The present invention relates to a method of transferring material between agricultural vehicles and to vehicles suitable for carrying out the method.

When a harvesting vehicle, such in particular as a forage harvester, does not have a tank of its own for harvested material it has to be constantly accompanied, while it is harvesting a field, by a transporting vehicle to which the crop which is picked up and chopped by the forage harvester is continuously transferred. To make it possible for the transfer to take place without any losses, the vehicles have to move in exact co-ordination throughout the whole of their travel in order to ensure that the discharge opening of a discharge chute belonging to the forage harvester is situated exactly over a load-carrying space of the transporting vehicle.

To alleviate these problems, it has already been proposed in EP 121 91 58 B1 that the transporting vehicle be remotely controlled automatically from the harvesting vehicle during transfer so that it will follow any change in the speed of the harvesting vehicle and any correction to its course. An opposite approach, namely the harvesting vehicle being remotely controlled from the transporting vehicle, is described in DE 100 57 374 A1.

It is true that these known techniques are very effective in keeping the load-carrying space of the transporting vehicle below a discharge opening of the harvesting vehicle at all times and in limiting losses during the transfer to a minimum, but the very effectiveness of the techniques does result in a fresh problem. Whereas, when the vehicles are being controlled manually, the position of the discharge opening over the load-carrying space cannot be held exactly constant and above all varies in the longitudinal direction of the vehicles, the elimination of variations of this kind as a result of one vehicle being remotely controlled results in the harvested material not being evenly distributed over the load-carrying space. Hence it can easily happen that the transfer has to be stopped before the transporting vehicle has reached its full capacity because the harvested material has heaped up to the level of the side-wall of the vehicle at one point on the load-carrying space.

However, no correcting action on the part of the driver of the remotely controlled vehicle is possible because the driver has to be able to take control of the remotely controlled vehicle again at any time if there is an emergency situation and for this reason any controlling action on his part will result in a switch back from the remotely controlled mode to the driver-controlled mode.

Therefore, embodiments of the invention specify a method of transfer, and vehicles suitable therefor, which on the one hand assist the transfer by controlling one vehicle remotely but which on the other hand enable full use to be made of the load-carrying capacity of the transporting vehicle.

### BRIEF DESCRIPTION OF THE DRAWINGS

Other features and advantages of the invention can be seen from the following description of embodiments which is given with by reference to the accompanying drawings. In the drawings:

FIG. 1 is a schematic view of a situation where the invention is used.

FIG. 2 is a flow chart of the control of the transporting vehicle shown in FIG. 1.

FIG. 3 shows a display means in the driver's cab of the transporting vehicle in a second embodiment of the invention.

FIG. 4 is a flow chart of the control of the transporting vehicle in the second embodiment.

### DETAILED DESCRIPTION OF THE INVENTION

It is true that a harvesting vehicle which has an integral tank, and in particular a combine harvester, does not need to be accompanied by a transporting vehicle for the whole of its travel, but transfer does takes place during a part of the travel and during this part of the travel the same co-ordination as with a forage harvester is needed with a transporting vehicle which takes over the harvested material.

Because the attention of the driver of the harvesting vehicle has to be very much concentrated on controlling functional sub-assemblies such as, say, front-mounted harvesting attachments or threshing or chopping units, what the driver of the transporting vehicle is generally required to do is to exactly follow the course of the harvesting vehicle. This task calls for close attention and a great deal of practice. Often, and particularly when the load-carrying space is on a trailer behind the transporting vehicle, the transporting vehicle has a lead of a few metres over the harvesting vehicle and when the latter has to make a curve (or turn) the transporting vehicle has to start the curve at an earlier point in time than the harvesting vehicle.

What this means is that, at a time when the harvesting vehicle is still travelling in a straight line, the transporting vehicle has to move in a direction in which it would collide with the harvesting vehicle if the latter did not change its direction, too. A manoeuvre of this kind takes considerable practice because it goes against the reflexes which are trained into one in road traffic. A further problem in making curves (or turns) results from the fact that a trailer follows a curve of smaller radius than the vehicle towing it. The driver of the transporting vehicle therefore has to estimate the path of the harvesting vehicle through a curve even before the harvesting vehicle has started its curve and then has to adjust the radius of the curve which the transporting vehicle follows in such a way that the resulting radius for the trailer is one at which the latter will remain in the transfer position relative to the harvesting vehicle.

Added to this is the fact that the transporting vehicle, for it to follow a curve of larger radius than the harvesting vehicle, has to be driven faster than the latter. It is therefore extremely difficult for a curve to be made while transfer is going on. In the case of a combine harvester the transfer can be interrupted during the curve and resumed when the two vehicles have again reached a suitable position next to one another at the beginning of a straight stretch. In the case of a forage harvester on the other hand some harvested material is lost if the transfer position is not maintained when a curve is made while harvesting is going on.

In an agricultural vehicle which supports a remotely controlled driven mode in which movement of the vehicle in travel is determined by information received from outside, this object is achieved by virtue of the fact that, in the remotely controlled driven mode, the vehicle is arranged, in the event of an intervention by the driver, to make a correction which is determined by said intervention to the movement of the vehicle in travel as determined by the information received from outside.

To enable driving also to take place independently of information which is received from outside, the vehicle can preferably be switched between a driver-controlled driven mode in which the movement of the vehicle in travel is determined by the driver and the remotely controlled driven mode.

It is useful for a distinction to be made between controlling interventions of a first type by the driver and controlling interventions of a second type. In this way, the vehicle is able to switch back to the driver-controlled mode automatically if an intervention of the first type by the driver at the control arrangement is sensed, whereas if an intervention of the second type is sensed, the correction which is determined by the driver's intervention is made to the movement of the vehicle in travel as determined by the information received from outside while maintaining the remotely controlled mode

The control arrangement generally comprises at least one control which is continuously movable in at least one degree of freedom such as, say, a steering wheel, accelerator pedal, brake pedal, or the like. What may be sensed as an action of the first type may then be a movement of the control having at least one degree of freedom whose amplitude reaches or exceeds a limiting value, whereas a movement of the control in the at least one degree of freedom whose amplitude does not exceed the limiting value is sensed as an action of the second type. In other words, there is a threshold for turning of the steering wheel and pressing of the accelerator or brake pedal from which such actuation results in a switch to the driver-controlled mode, whereas when the actuation is below the limiting value the remotely controlled mode is maintained and the movement of the vehicle is simply corrected in line with the actuation of the control. In this way, control of the vehicle is given back to the driver in an emergency situation, which generally calls for forceful actuation of the control, whereas in the case of gentle actuation, which is all that is required for correcting the positions of the vehicles relative to one another, the remotely controlled mode is maintained.

If the control is an accelerator pedal, simply a fully depressed position of the accelerator pedal can be adopted as a limiting value. Because the driver will generally actuate the control at a higher speed when reacting to an emergency, the speed of actuation of the control can also be adopted as a criterion for distinguishing between an action of the first type and an action of the second type.

There may be provided in the vehicle a display means which displays to the driver a switchover between the remotely controlled and driver-controlled modes. In this way, the driver will be given a warning if, due to a controlling action, the vehicle switches back to the driver-controlled mode and he once again has to ensure that correct control takes place. The display means can also be used to indicate to the driver how far away from the switchover threshold a control action is even though a switchover does not actually occur. This gives the driver an additional measure of safety when he has to take a controlling action.

It is also conceivable for an auxiliary control to be provided which has at least two states, actuated and not actuated, and for a movement of the other control to be sensed as an action of the first type or as an action of the second type as dictated by the state of the auxiliary control. In other words, the driver can, by operating the auxiliary control together with the other control, decide whether or not the remotely controlled mode is to be maintained.

Another useful possibility is for a first control to be provided to control a variable which is selected from direction of travel and speed of travel and for a second control to be provided to act on this same variable, at least in the remotely controlled mode, the vehicle being arranged to sense an action by the driver on the first control as an action of the first type and to sense an action by the driver on the second control as an action of the second type.

The first and second controls need not necessarily be redundant; in a preferred embodiment the first control may for example be a brake pedal and the second control a clutch pedal. In this way, although the two controls do not perform the same function, each of them is, nevertheless, suitable to cause the vehicle to decelerate.

The variable which is selected from direction of travel and speed of travel may also be acted on indirectly by enabling a desired position of the vehicle relative to a reference point to be set at the second control. The selection of the controlling manoeuvre which is required to bring about the desired position can then be left to an automatic means. To make it easier for the driver to select the desired position, a display member is usefully provided to show the desired position.

A radio interface is preferably provided to receive the information which determines direction and speed of travel in the remotely controlled mode. By another vehicle transmitting control commands, which it receives for example from its driver, to the radio interface, both vehicles are able to react in synchronisation to these control commands.

The radio interface is usefully arranged to itself transmit a message when there is a transition to the driver-controlled mode. When the vehicle whose mode can be switched over is the transporting vehicle, whereas the vehicle which transmits the information determining direction and speed of travel is the harvesting vehicle, then the harvesting vehicle can automatically stop the transfer of harvested material when the message is received and in this way can prevent any losses of harvested material. If the vehicle whose mode can be switched over is the harvesting vehicle and it is the transporting vehicle which receives the message, then the fact of receipt can usefully be indicated to the driver of the transporting vehicle to make him aware that the transfer has stopped and that he no longer needs to make allowance for the harvesting vehicle as he continues to drive.

Conversely, it may also be sensible for the radio interface to transmit a message when there is a transition to the remotely controlled mode, e.g. to give the go-ahead for the transfer of harvested material from the harvesting vehicle to the transporting vehicle or to make the driver of the transporting vehicle aware that he has to make allowance for the harvesting vehicle in his controlling operations.

To complement the controlled vehicle which has been described above, the invention also relates to a controlling agricultural vehicle and in particular to a vehicle having means for sensing its own movement in travel, having an interface for broadcasting information defining the movement in travel to at least one other vehicle, and having a user interface for entering a correction representing a difference between the movement in travel which is defined in the information and the movement in travel which is sensed.

The vehicles may be any desired pairs of agricultural vehicles which are working together and whose work together calls for the transfer of material, regardless of whether this is in the course of recovery of material from the field or distribution thereof on it. Such pairs may, in particular, comprise: a harvesting vehicle and a transporting vehicle, a transporting vehicle and a seed broadcaster, a transporting vehicle and a fertiliser spreader, etc.

The object is also achieved by a method for the combined operation of two agricultural vehicles (1, 2) which has the following steps:
transmission of information defining a movement in travel of one of the two vehicles from one vehicle to the other,
control of the other vehicle by reference to the information transmitted,
sensing of controlling actions taken by the driver of at least one of the vehicles (S4, S6-S8, S10; S4′-S9′),
correction of the information by reference to a controlling action which is sensed.

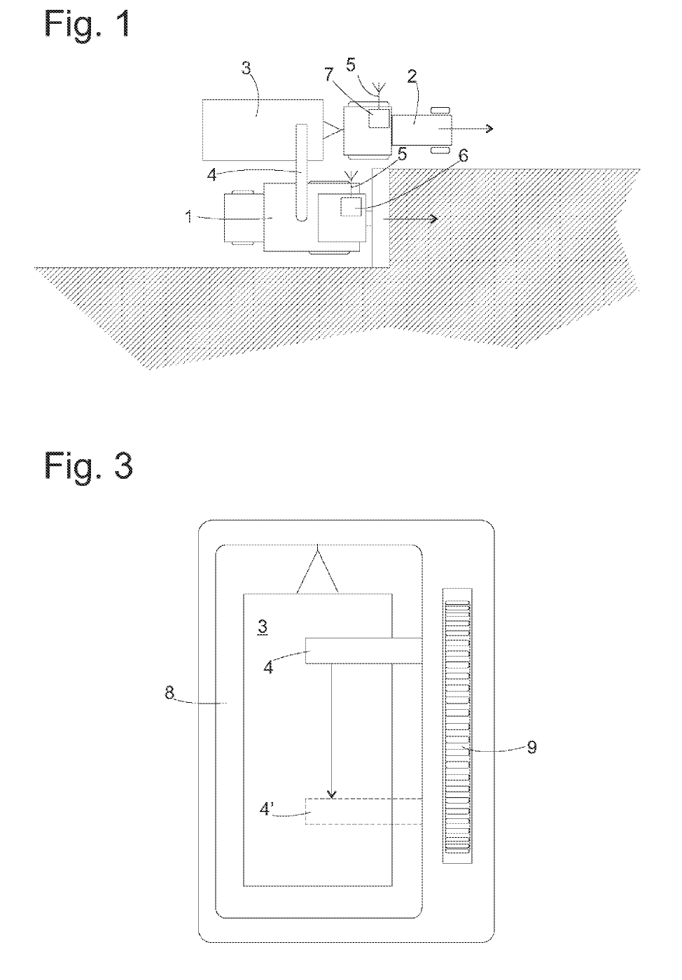

FIG. 1 is a schematic plan view showing a combine harvester 1 and a transporting vehicle, which in this case is a tractor 2 having a trailer 3, which move together over a cultivated area to allow harvested grain to be transferred from the grain tank of the combine harvester 1 to the trailer 3 with the help of a discharge tube 4 belonging to the combine harvester 1. Both vehicles, the combine harvester 1 and the tractor 2, are in motion during the transfer and the combine harvester 1 is simultaneously harvesting a part of the cultivated area, which is shown hatched in the drawing, on which there is still grain.

The two vehicles have respective radio interfaces 5 for bi-directional communication with one another and for the reception of satellite signals, of the GPS type for example, which enable a control processor 6 of the combine harvester 1 to find the position and current course of the combine harvester 1.

When the level to which a grain tank fitted to the combine harvester 1 is filled exceeds a critical value, the tractor 2 receives, via its radio interface 5, an instruction to meet up with the combine harvester 1 to take over the grain which has been harvested. The instruction may come straight from the combine harvester 1, either as a result of the driver of the combine harvester 1 deliberately transmitting the instruction or as a result of the control processor 6 of the combine harvester 1 transmitting it automatically when the critical level for the filling of the tank is reached, or it may come from a central master control point which monitors the transfer requirements of a plurality of combine harvesters 1 which are being used in co-ordination with one another and which orders one or more transporting vehicles out to the combine harvesters 1 as and when required.

As soon as the tractor 2 has reached a position next to the combine harvester 1 in which transfer is possible, the driver of the tractor 2 switches its control processor 7 from a driver-controlled mode to a mode which is remotely controlled by the adjacent combine harvester 1 and in which the speed and course of the tractor 2 are each adjusted in line with commands which are transmitted by radio from the combine harvester 1 (a simplified embodiment would also be conceivable in which it was only the course or only the speed which was transmitted to the tractor and the correct control of whichever was the other parameter remained the responsibility of the driver).

Because, in the commands transmitted, the combine harvester 1 specifies its own direction of travel as an angular difference from a reference direction which can be laid down with the help of the GPS signals, the tractor 2 is able to adopt a direction of travel which is exactly parallel to the direction of travel of the combine harvester 1 without requiring for the purpose any sensors for directly measuring its own position relative to the combine harvester 1. However, sensors of this kind, e.g. ultrasonic distance sensors, are preferably present to enable the control processor 7 to automatically correct any movements off course which result from any inexactness in the steering of the vehicles 1, 2.

The combine harvester 1 may be steered by a driver, or it may itself be remotely controlled by a stationary master computer. In the latter case, rather than receiving it from the combine harvester 1, the tractor 2 may also receive its controlling information direct from the master computer. Another alternative which may be considered is automatic steering of the combine harvester, e.g. by sensing of the edge of the area of the field which still has to be harvested with the help of a laser sensor or the like.

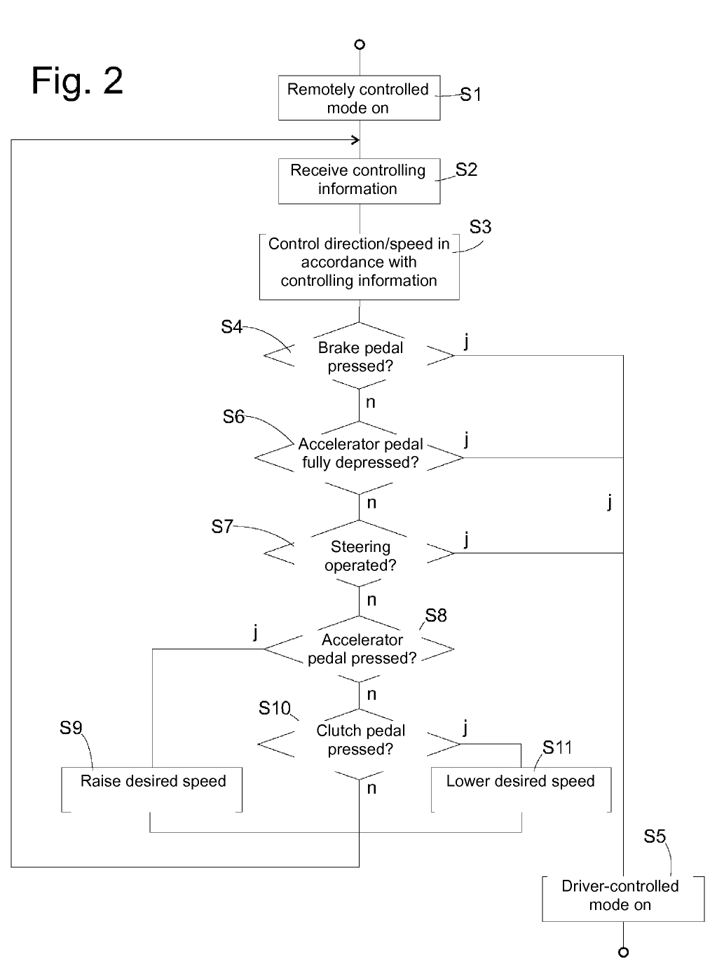

FIG. 2 shows the operation of a control processor 7 belonging to the tractor 2 in detail, during transfer in the remotely controlled mode, by means of a flow chart. The flow chart starts with a step S1 of switching on the remotely controlled mode, which is done for example by pressing a key on the dashboard of the tractor 2 once the latter has reached, alongside the combine harvester 1, a position suitable for transfer in which the free end of the discharge tube 4 is safely over the trailer 3. The tractor 2 confirms the transition to the remotely controlled mode by a radio signal. As from this point in time, the direction of travel and speed of travel of the tractor 2 are laid down by controlling information which the latter receives from outside.

In the simplest case the controlling information comprises details, which are transmitted from the combine harvester 1 by radio, of the latter's own direction of travel and speed, which direction of travel and speed are set in an identical form at the tractor 2. To stop the two vehicles from drifting apart in operation, the tractor 2 preferably receives further controlling information in step S2, such for example as information determined with the help of ultrasonic sensors on the distance between the combine harvester 1 and the tractor 2 and on the direction in which the combine harvester 1 is lying in relation to a fixed co-ordinate system on the tractor 2. In step S3 the tractor 2 sets its direction of travel and speed in line with the data transmitted by the combine harvester 1, and if any drift is sensed with the help of the ultrasonic sensors it corrects it. By repeating steps S2, S3 sufficiently frequently, the vehicles 1, 2 are able to drive along next to one another for an arbitrary length of time without any substantial change in the position of the discharge tube 4 above the load-carrying space of the trailer 3.

When the combine harvester 1 has to make a curve (or turn) while the tractor 2 is in the remotely controlled mode, then the combine harvester 1 can make allowance for this when it transits the data on direction of travel and speed to the tractor 2 by calculating for the latter a radius of curve which is increased or reduced by the length of the discharge tube 4 and a speed which is adjusted in proportion to the ratio between the radii of curve.

As soon as the combine harvester 1 receives the message on the transition to the remotely controlled mode from the tractor 2 in step S1, it can start transferring grain from its tank to the trailer 3. However, provision may also be made for the transfer only to begin with a certain delay after receipt of the confirmation in order to ensure that the vehicles 1, 2 are driving along reliably next to one another and that this state can be maintained for as long as is necessary.

As long as the tractor 2 is in the remotely controlled mode, a continuing check is made on whether the driver makes any corrections to the direction or speed of travel of the tractor 2. In this way it is determined, in step S4 say, whether the driver has pressed the brake pedal of the tractor. If he has, the control processor of the tractor 2 in step S5 immediately switches back to the driver-controlled mode, and the driver thus again has complete control of the tractor 2. In this way, there is nothing to prevent the driver from bringing the tractor 2 to a halt, out of the remotely controlled mode, when this has to be done to, for example, avoid a collision with an obstacle.

The return to the driver-controlled mode in step S5 is accompanied by the transmission of a message to this effect over the radio interfaces 5 to the combine harvester 1. This gives the driver of the combine harvester 1, or a control system belonging to it, an opportunity to break off the transfer without delay so that no harvested material is lost, if the discharge tube 4 is no longer situated above the trailer 3.

In step S6, the control processor 7 of the tractor 2 checks to see whether the accelerator pedal of the tractor 2 may have been fully depressed. If it has, it can be assumed that this is a reaction by the driver of the tractor to a dangerous situation. Therefore, in this case too, the control processor jumps directly to step S5, changes to the driver-controlled mode and transmits a message to this effect to the combine harvester 1 to cause the latter to bring the transfer to an end.

Provision for an immediate switch to the driver-controlled driven mode may similarly be made if actuation of the steering has been sensed in step S7. Because there is generally no need for any action to be taken on the steering in the remotely controlled mode, the fact that the driver actuates the steering is a sure indication, regardless of the amplitude of the steering movement, that he needs full control of the tractor 2.

In step S8, the position of the accelerator pedal is again assessed. In step S9, any pressing of the accelerator pedal results in the desired speed being raised above the value which is laid down by reference to the information received from the combine harvester 1. The result of the raising of the desired speed is that the tractor 2 slowly advances relative to the combine harvester 1 and that the point on the trailer 3 above which the discharge opening of the discharge tube 4 is situated moves backwards in relation to the trailer 3. In this way, if it was in essence a front region of the trailer 3 which was being loaded before the desired speed was raised, a rear region can now be loaded. In this way the harvested material is evenly distributed over the load-carrying space and full use is made of the load-carrying capacity of the trailer 3.

Like a pressing of the brake, the pressing of a clutch or inching pedal of the tractor 2 results, in the driver-controlled mode, in the tractor 2 decelerating. In the remotely controlled mode, the control processor does not react to pressing of the clutch pedal by a forced disengagement of the clutch; in the remotely controlled mode the clutch is under the sole control of the control processor 7. Instead, the control processor 7 reacts to pressing of the clutch pedal in step S10 by reducing the desired speed (step S11), i.e. the discharge tube 4 moves forward over the load-carrying space of the trailer 3.

In this way, by pressing the accelerator pedal to less than the fully depressed position or pressing the clutch pedal, as desired, the driver has an opportunity of selecting the desired speed of the tractor 2 to be different from that of the combine harvester 1 and in this way of changing the position of the discharge tube 4 above the trailer 3 in such a way that the load-carrying ability of the trailer can in every case be exploited in the optimum way.

In a modification of the method shown in FIG. 2, provision may be made, in step S7, for not every actuation of the steering to result in a transition to the driver-controlled mode but for only an action on the steering which exceeds a preset limiting angle to do so. Where there is a simple automatic control system which does not sense the distance between the combine harvester and tractor and keep it constant, this gives the driver of the tractor 2 an opportunity of keeping this distance constant manually without this resulting in the remotely controlled mode being cut short.

In the event of there being a more sophisticated automatic control system which is arranged to keep the distance between the combine harvester and tractor constant, the remotely controlled mode is not exited provided the intervention on the steering remains below the limiting angle and by this means the driver is given an opportunity, while going through a curve, to vary the distance between the lines followed by the tractor and combine harvester in such a way that the tractor remains in the transfer position relative to the combine harvester even in the curve. By means of a display means which continuously indicates the relationship between the intervention on the steering and the limiting angle, the driver can, when necessary, ascertain whether and to what extent he is able to increase the intervention taken on the steering without thereby exiting the remotely controlled mode.

As a further modification, provision may be made for actuation of the steering to result in a transition to the driver-controlled mode if the speed of the actuation exceeds a preset limiting value. This makes it possible even for tight curves to be driven through without exiting the remotely controlled mode.

If, for too long a time, the desired speed of the tractor is kept higher or lower than that of the combine harvester 1 or the direction of travel of the tractor 2 is kept different from that of the combine harvester 1, or if a correcting manoeuvre proves to be excessive, the possibility exists that the overlap between the discharge tube 4 and the trailer 3 may be lost. To prevent this from happening, provision is made, in a useful refinement, for the size of a correction of direction or speed to be limited in the remotely controlled mode. In this way, provision may for example be made in the remotely controlled mode for pressing of the accelerator pedal to result in an increase of speed over the speed transmitted from the combine harvester 1 of a maximum of 2 km/h and for pressing of the clutch to result in deceleration of a maximum of 2 km/h, and/or for actuation of the steering wheel to result in a difference from the direction transmitted from the combine harvester 1 of a maximum of 2°. In this way, the driver has enough time to observe the effect of a correcting manoeuvre and to bring it to an end when a desired new relative position between the vehicles 1, 2 has been reached.

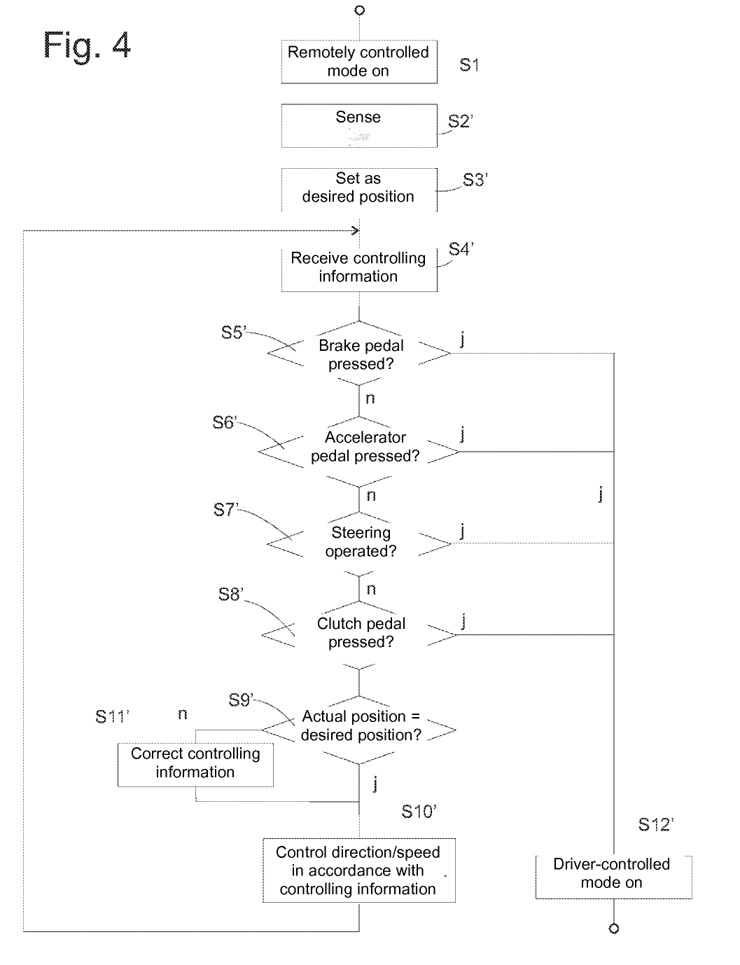

Loss of the overlap between the discharge tube 4 and trailer 3 can also be ruled out in the embodiment of the invention which will be described in what follows by reference to FIGS. 3 and 4. In this case the tractor 2 is fitted with sensors of any desired kind to sense the position of the combine harvester 1, and in particular that of its discharge tube 4, relative to the tractor 2. These sensors may for example be ultrasonic sensors which are aligned towards the discharge tube 4 from the tractor, i.e. obliquely from below, and which are therefore able to pick up an echo of the discharge tube 4 which is largely free of background noise. A display screen 8 which is shown in FIG. 3 is provided in the driver's cab of the tractor 2 to show the position of the combine harvester 1 relative to the tractor 2, in the present case in the form of a schematic plan view which shows the trailer 3 and the end of the discharge tube 4 which projects over it. Arranged adjacent to the display screen 7 is an adjuster, e.g. a scrolling wheel 9, which gives the driver of the tractor 2 an opportunity of setting a different desired position for the discharge tube 4 over the trailer 3. The desired position for the discharge tube 4 which differs from its actual position is shown on the display screen 8 in the form of for example a dashed outline 4′. FIG. 3 shows only one scrolling wheel 9 for adjusting the desired position in the longitudinal direction of the trailer 3; a second such wheel may be provided for adjusting the desired position in the transverse direction.

A flow chart for the second embodiment is shown in FIG. 4 and will be described below. A switch to the remotely controlled mode (S1) takes place when the tractor 2 has reached a position at the combine harvester 1 which is suitable for transfer and when the driver of the tractor 2 presses an appropriate key. It is also possible for it to be sensed, by means of sensors, when the discharge tube 4 is in a position suitable for transfer above the trailer 3 and, when it is, for the remotely controlled mode to be switched to automatically or for the driver of the tractor 2 then to be given a signal which tells him that it is possible to switch to the remotely controlled mode. The position which the tractor 2 is in relative to the combine harvester 1 at the time of the switch to the remotely controlled mode is sensed in step S2′ and is set as a desired relative position in step S3′.

In step S4′ the tractor 2 receives information on direction of travel and speed from the combine harvester 1. Following this (steps S5′-S8′), various controls of the tractor 2, such as, say, the brake pedal, accelerator pedal, steering or clutch pedal, are checked for actuation. Any such actuation results in a return to the driver-controlled mode in step S12′. A message to this effect is transmitted to the combine harvester 1 to cause the latter to interrupt the transfer of harvested material.

If the tractor 2 remains in the remotely controlled mode, Step S9′ checks whether the actual position of the discharge tube 4 which is sensed by the sensors still tallies with the desired position thereof. A difference between the desired and actual position may arise in particular if the driver has operated the scrolling wheel 9 in the manner described above. If there is no difference, the control processor controls the direction and speed of the tractor 2 by reference to the controlling information received from the combine harvester 1, i.e. the position of the discharge tube 4 above the trailer 3 is left unchanged.

If however a difference is found between the actual and desired positions, the control processor 7 corrects the controlling information in step S11′, i.e. it raises or lowers the desired speed as dictated by the direction of the difference. In this way, the difference becomes smaller and smaller in the course of a plurality of iterations of the process shown in FIG. 4 and as soon as it is found in step S9′ that the actual and desired positions tally again, control again takes place precisely by reference to the controlling information supplied by the combine harvester 1.

In this way, by adjusting the desired position of the discharge tube 4 once or more than once during a transfer operation, the driver of the tractor 2 can ensure that the harvested material is evenly distributed in the trailer 3 without there being any risk of the overlap between the discharge tube 4 and the trailer 3 being lost.

In a further embodiment, an adjuster performing a function similar to the scrolling wheel 9 is provided on board the combine harvester 1, possibly in conjunction with a display screen 8. The driver of a combine harvester is generally better able to observe the load-carrying space than the driver of the transporting vehicle and, with the help of the scrolling wheel 9, is better able to apply to the information which defines the movement of the combine harvester 1 and which is transmitted to the transporting vehicle 2 an offset which results in a general change in the position of the discharge tube 4 above the load-carrying space of the trailer 3.

The invention has been described above specifically in relation to interaction between a combine harvester and a transporting vehicle. It can however readily be transferred to other co-operating pairs of agricultural vehicles which exchange material in operation such as, say, a transporting vehicle and a vehicle for distributing seeds, fertiliser, plant protection agents, etc.

We claim:

1. An agricultural vehicle able to be driven in a remotely controlled mode in which movement of the vehicle (2) in travel is determined by information received from outside, characterised in that, in the remotely controlled driven mode, the vehicle is arranged, in the event of an intervention by the driver (S8, S10), to make a correction (S9, S11; S11′) determined by the driver's intervention to the movement of the vehicle in travel as determined by the information received from outside.

2. The agricultural vehicle according to claim 1, characterised in that it can be switched between a driver-controlled driven mode in which the movement of the vehicle (2) in travel is determined by the driver and the remotely controlled driven mode.

3. The agricultural vehicle according to claim 2, characterised in that it is arranged, in the remotely controlled driven mode, to monitor (S4, S6, S7; S5′-S8′) a control arrangement able to be operated by the driver, to switch back (S5; S12′) to the driver-controlled mode if an intervention of a first type by the driver at the control arrangement is sensed, and if an action of a second type is sensed, while maintaining the remotely controlled mode, to make (S9, S11; S11′) the correction which is determined by the intervention taken by the driver to the movement of the vehicle in travel as determined by the information received from outside.

4. The agricultural vehicle according to claim 3, characterised in that the control arrangement (7) comprises a control which is continuously movable in at least one degree of freedom, and in that an action of the first type is a movement of the control in the at least one degree of freedom whose amplitude reaches or exceeds a limiting value (S6), and an action of the second type is a movement of the control in the at least one degree of freedom whose amplitude does not reach or exceed the limiting value (S8).

5. The agricultural vehicle according to claim 4, characterised in that the control is an accelerator pedal, and in that the limiting value is a fully depressed position of the accelerator pedal.

6. The agricultural vehicle according to claim 3, characterised in that the control arrangement has a control which is continuously movable in at least one degree of freedom, and in that an intervention of the first type is a movement of the control in the at least one degree of freedom whose speed reaches or exceeds a limiting value, and an intervention of the second type is a movement of the control in the at least one degree of freedom whose speed does not reach or exceed the limiting value.

7. The agricultural vehicle according to claim 4, characterised by a display means to display the relationship of the magnitude of the intervention to the limiting value.

8. The agricultural vehicle according to claim 3, characterised in that the control arrangement has a control which is continuously movable in at least one degree of freedom, and an auxiliary control which has at least two states, and in that a movement of the control is sensed as an intervention of the first type or as an intervention of the second type as dictated by the state of the auxiliary control.

9. The agricultural vehicle according to claim 3, characterised in that the control arrangement has a first control to control a variable which is selected from direction of travel and speed of travel and a second control to act on this same variable, at least in the remotely controlled mode, and in that the vehicle is arranged to sense an intervention by the driver on the first control as an intervention of the first type (S4; S5′-S8′) and to sense an intervention by the driver on the second control (9) as an intervention of the second type (S10; S11′).

10. The agricultural vehicle according to claim 9, characterised in that the first control is a brake pedal and the second control is a clutch pedal.

11. The agricultural vehicle according to claim 9, characterised in that a desired position of the vehicle (2) relative to a reference point (4) can set at the second control (9).

12. The Agricultural vehicle according to claim 11, characterised in that it has a display member (8) to show the desired position.

13. The Agricultural vehicle according to one claim 1 characterised in that it has a radio interface (5) to receive the information which determines direction and speed of travel in the remotely controlled mode.

14. The agricultural vehicle according to claim 2, characterised in that the radio interface (5) is arranged to transmit a message when there is a transition to the driver-controlled mode (S5; S12′).

15. Agricultural vehicle according to claim 2 characterised in that the radio interface (5) is arranged to transmit a message when there is a transition to the remotely controlled mode (S1).

16. An agricultural vehicle having means for sensing a movement of the vehicle in travel and having an interface for broadcasting information defining the movement in travel to at least one other vehicle, characterised by a user interface for entering a correction representing a difference between the movement in travel which is defined in the information and the movement in travel which is sensed.

17. A method for the combined operation of two agricultural vehicles (1, 2) which has the following steps:
transmission of information defining a movement in travel of one of the two vehicles from one vehicle to the other,
control of the other vehicle by reference to the information transmitted,
sensing of controlling interventions taken by the driver of at least one of the vehicles (S4, S6-S8, S10; S4′-S8′),
correction of the information by reference to a controlling intervention which is sensed.
